(19) United States
(12) Patent Application Publication
(10) Pub. No.: US 2016/0295186 A1
(43) Pub. Date: Oct. 6, 2016

(54) WEARABLE PROJECTING DEVICE AND FOCUSING METHOD, PROJECTION METHOD THEREOF

(71) Applicant: BOE TECHNOLOGY GROUP CO., LTD., Beijing (CN)

(72) Inventors: Yanshun CHEN, Beijing (CN); Xingxing ZHAO, Beijing (CN); Qiushi XU, Beijing (CN); Yaohui LI, Beijing (CN)

(21) Appl. No.: 14/442,565

(22) PCT Filed: Sep. 30, 2014
(86) PCT No.: PCT/CN2014/087862

§ 371 Date: May 13, 2015

(30) Foreign Application Priority Data
Apr. 28, 2014 (CN) 201410175303.7

(51) Int. Cl. H04N 9/31; G02B 7/09; H04N 5/247; G02B 7/28; G03B 21/28; H04N 13/04; G03B 21/14; G02B 7/36

(52) U.S. Cl. CPC H04N 9/3194; G03B 21/142; G02B 7/09; G02B 7/36; G02B 7/285; G03B 21/28; H04N 9/3173; H04N 13/04; H04N 5/247

(57) ABSTRACT

A wearable projecting device, a focusing method and a projection method thereof are disclosed. The focusing method includes: acquiring position information of a projection center of the wearable projecting device on a palm; determining a distance between the projection center and the wearable projecting device according to the acquired position information of the projection center of the wearable projecting device on the palm at a set frequency; determining a focal length of a lens set in the wearable projecting device according to the determined distance between the projection center and the wearable projecting device; and adjusting the lens set according to the determined focal length of the lens set. This focusing method improves stability of definition in display of images projected on the palm surface by the wearable projecting device.

### TECHNICAL FIELD

Embodiments of the present invention relate to a wearable projecting device and a focusing method, a projection method thereof.

### BACKGROUND

Wearable projecting device implements projection based on a particular background, namely a palm, as the screen for projection. A wearable projecting device is typically wearable on a finger in operation. Because relative position between the wearable projecting device and the palm surface often varies due to finger's shaking etc., the stability of definition in display of images projected onto the palm surface by the wearable projecting device is poor.

### SUMMARY

The present invention provides a wearable projecting device, a focusing method, and a projection method thereof, which realize high stability of definition in display of images projected on to the palm surface by the wearable projecting device.

At least one embodiment of the present invention provides a focusing method of a wearable projecting device comprising carrying out the following steps at a set frequency: acquiring position information of a projection center of the wearable projecting device on a palm; determining a distance between the projection center and the wearable projecting device according to the acquired position information of the projection center of the wearable projecting device on the palm; determining a focal length of a lens set in the wearable projecting device according to the determined distance between the projection center and the wearable projecting device; and adjusting the lens set according to the determined focal length of the lens set.

In one example, between two successive executions of adjusting lens set according to the determined focal length of lens set, the wearable projecting device is controlled to project at least two frames of images, and within a duration of the at least two frames of images, definition information of a projected image on the palm after one frame is projected is further acquired; then, it is determined whether the definition of projected image is within a predetermined range according to the acquired definition information of the projected image, and if not, the focal length of the lens set is corrected according to determined focal length correction information during the period of projecting the next frame of image.

In one example, the set frequency at which the steps are executed is 30 Hz.

At least one embodiment of the present invention further provides a projection method of a wearable projecting device comprising carrying out the following steps at a set frequency: acquiring position information of a projection center of the wearable projecting device on a palm; determining a distance between the projection center and the wearable projecting device according to the acquired position information of the projection center of the wearable projecting device on the palm; determining a focal length of a lens set in the wearable projecting device according to the determined distance between the projection center and the wearable projecting device; adjusting the lens set according to the determined focal length of the lens set; and controlling the wearable projecting device to conduct projection.

In one example, between two successive executions of adjusting lens set according to the determined focal length of lens set, the wearable projecting device is controlled to project at least two frames of images, and within a duration of the at least two frames of images, definition information of a projected image on the palm after one frame is projected is further acquired; then, it is determined whether the definition of projected image is within a predetermined range according to the acquired definition information of the projected image, and if not, the focal length of the lens set is corrected according to determined focal length correction information during the period of projecting the next frame of image.

In one example, the set frequency in the carrying out the following steps at a set frequency is 30 Hz; and the projection frequency of the wearable projecting device in the controlling the wearable projecting device to conduct projection is 60 Hz.

In one example, the determining the distance between the projection center and the wearable projecting device according to the acquired position information of the projection center of the wearable projecting device on the palm comprises: establishing a space coordinates system with an origin at the location of the wearable projecting device; determining coordinates of the projection center in the space coordinate system according to the acquired position information of the projection center; and determining a distance between the projection center and the wearable projecting device according to the determined coordinates of the projection center and the set origin coordinates.

At least one embodiment of the present invention further provides a wearable projecting device comprising: a rack; a lens set mounted on the rack; an adjusting device mounted on the rack for adjusting focal length of the lens set in operation; a 3D camera mounted on the rack for acquiring position information of a projection center of the wearable projecting device on a palm; and a processing module in signal connection with the 3D camera and the adjusting device. the processing module is configured to carry out the following operations at a set frequency: determining the distance between the projection center and the wearable projecting device according to the acquired position information of the projection center, on the palm, of the wearable projecting device; and then determining the focal length of the lens set in the wearable projecting device according to the determined distance between the projection center and the wearable projecting device, generating an adjusting signal and controlling the adjusting device to adjust the focal length of the lens set according to the adjusting signal.

In one example, the wearable projecting device further includes a second camera in signal connection with the processing module for acquiring definition information of images projected onto the palm after each frame of image is projected; and the processing module further determines whether definition of a projected image is within a predetermined range according to the definition information of the projected image acquired by the second camera, and if not, controls the adjusting device to correct the focal length of the lens set during the period of projecting the next frame according to determined focal length correction information.

In one example, the 3D camera is a structured-light camera, a TOF (time-of-flight) camera or a binocular camera.

In one example, the adjusting device is a stepping motor.

In one example, an arc-shaped reflector on a light emission side of the lens set is further included. A distance between the reflector and the lens set is greater than or equal to two times the focal length of the lens set; light emission direction of the lens set is apart from the palm surface, and the projection light emitted from the lens set irradiates on the palm surface after being reflected by the reflector to form a projection image on the palm surface.

In one example, the focal length of the lens set is less than or equal to 5 mm.

### BRIEF DESCRIPTION OF DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a flow chart of a focusing method provided in an embodiment of the present invention;

FIG. 2 is a flow chart of a projection method provided in an embodiment of the present invention;

FIG. 3 is a principle diagram of a wearable projecting device provided in an embodiment of the present invention; and

FIG. 4 is a light path diagram of a wearable projecting device provided in an embodiment of the present invention.

### DETAILED DESCRIPTION

The technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

At least one embodiment of the present invention provides a wearable projecting device, a focusing method, and a projection method thereof. The images projected onto a palm surface by the wearable projecting device have high stability of definition in display when the wearable projecting device implements projection onto the palm using the above-mentioned focusing method and the projection method.

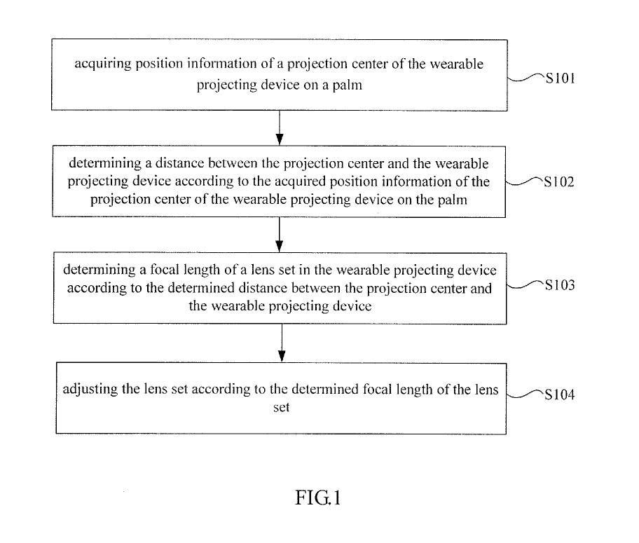

Refer to FIG. 1, which is a flow chart of the focusing method provided in one embodiment of the present invention.

The focusing method of a wearable projecting device according to the present embodiment includes carrying out the following steps at a pre-set frequency:

step S101, acquiring position information of the projection center of a wearable projecting device on a palm;

step S102, determining the distance between the projection center and the wearable projecting device according to the acquired position information of the projection center of the wearable projecting device on the palm;

step S103, determining the focal length of a lens set in the wearable projecting device according to the determined distance between the projection center and the wearable projecting device; and

step S104, adjusting the focal length of the lens set according to the determined focal length.

In the present embodiment, when the wearable projecting device implements projection after adjusting the focal length of the lens set with the above-mentioned focusing method, first of all, in step S101, the position information of the projection center of the wearable projecting device on the palm surface is acquired by for example a 3D (three dimension) camera and then transmitted to a processing module; in step S102, the distance between the projection center and the wearable projecting device is calculated by the processing module with a set frequency; in step S103, the focal length required by the lens set is determined according to the calculated distance between the projection center and the wearable projecting device and an adjusting signal is generated; and then in step S104, an adjusting device is controlled to adjust the focal length of the lens set of the wearable projecting device such that the focal length of the lens set is adjusted to correspond to the distance between the projection center and the wearable projecting device calculated by the processing module and the definition in display of images projected onto the palm by the wearable projecting device is improved.

Furthermore, when the wearable projecting device of the embodiment implements projection on a palm surface by the projection method using the above-mentioned focusing method, the processing module can control an adjusting device with a set frequency to adjust the focal length of a lens set, and therefore it is possible to adjust the focal length of the lens set in time when the finger position changes such that the stability of definition in display of images projected onto the palm surface by the wearable projecting device can be improved.

In one embodiment of the present invention, between two successive executions of steps S104 of adjusting a lens set according to the determined focal length of the lens set, the wearable projecting device is controlled to project at least two frames of images, and within the duration of the above-mentioned at least two frames of images, definition information of the projected image on the palm after one frame is projected is acquired. Then, it is determined whether the definition of projected image is within a predetermined range or not according to the acquired definition information of the projected image, and if not, the focal length of the lens set is corrected according to determined focal length correction information during the period of projecting the next frame of image.

In the above-mentioned focusing method in the embodiment of the present invention, during the time in which step S104 is executed twice successively, it is possible to acquire the definition information of one frame of image projected onto the palm surface by the wearable projecting device by means of, for example, an RGB camera. Then, the acquired definition information signal is transmitted to the processing module that determines whether the definition of projected image is within a predetermined range or not according to the acquired definition information of the projected image. If it is determined that the definition is not within a determined threshold range, which indicates the focal length of the lens set is not correctly adjusted, then the processing module corrects the focal length of the lens set according to the determined focal length correction information in the projection period for the next frame, for example, by allowing the displayed images to approach the most clear state in the period of a plurality of frames in an approaching manner, thereby guaranteeing the definition of images displayed on palm by the wearable projecting device.

An RGB camera uses three different cables to output three fundamental color components and generally uses three independent sensors (CCD or CMOS) to acquire three color signals. Therefore, RGB cameras are often used for accurate color image acquisition. Other kinds of cameras may also be used in embodiments of the present invention to acquire images for analysis and determination of definition in display.

In the focusing method provided in one embodiment of the present invention, the frequency at which the above-mentioned steps S102, s103 and S104 are executed is set to be 30 Hz.

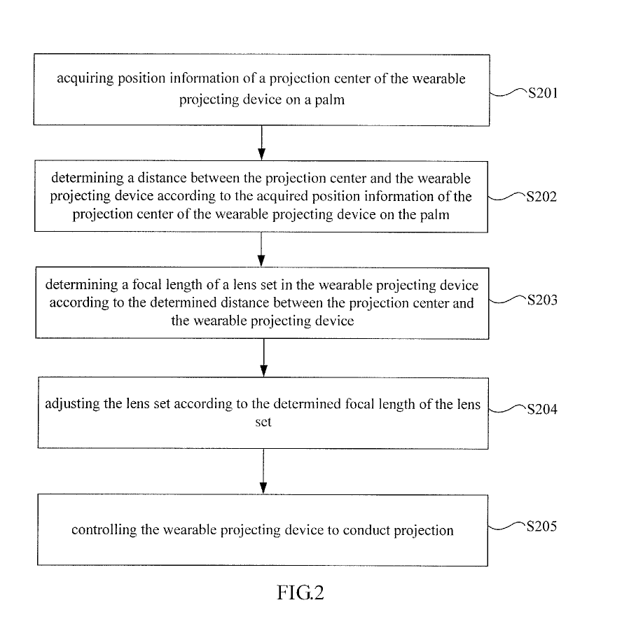

As shown in FIG. 2, on the other hand, an embodiment of the present invention provides a projection method including carrying out the following steps at a set frequency:

step S201, acquiring position information of the projection center of the wearable projecting device on a palm;

step S202, determining the distance between the projection center and the wearable projecting device according to the acquired position information of the projection center of the wearable projecting device on the palm;

step S203, determining the focal length of a lens set in the wearable projecting device according to the determined distance between the projection center and the wearable projecting device;

step S204, adjusting the focal length of the lens set according to the determined focal length; and

step S205, controlling the wearable projecting device to conduct projection.

In the present embodiment, when the wearable projecting device implements projection by the above-mentioned projection method, first of all, in step S201, the position information of the projection center of the wearable projecting device on the palm surface is acquired by means of for example a 3D camera and then transmitted to a processing module; in step S202, the distance between the projection center and the wearable projecting device is calculated by the processing module with a set frequency; in step S203, a focal length required by the lens set is determined according to the calculated distance between the projection center and the wearable projecting device and an adjusting signal is generated; and then in step S204, an adjusting device is controlled to adjust the focal length of the lens set of the wearable projecting device such that the focal length of the lens set is adjusted to correspond to the distance between the projection center and the wearable projecting device calculated by the processing module; then in step S205, the wearable projecting device is controlled to conduct projection such that the definition of images projected onto the palm by the wearable projecting device is improved accordingly.

Furthermore, when the wearable projecting device of the embodiment implements projection on a palm surface by the above-mentioned projection method, the processing module can control an adjusting device at a set frequency to adjust the focal length of a lens set, and therefore it is possible to adjust the focal length of the lens set in time when the finger position changes such that the stability of definition in display of images projected onto the palm surface by the wearable projecting device can be improved as well.

In one embodiment of the present invention, between two successive executions of steps S204 of adjusting a lens set according to the determined focal length of the lens set, the wearable projecting device is controlled to project at least two frames of images, and within the duration of the above-mentioned at least two frames of images, the definition information of a projected image on the palm after one frame is projected is further acquired. It is determined whether the definition of projected image is within a predetermined range or not according to the acquired definition information of the projected image, and if not, the focal length of the lens set is corrected according to determined focal length correction information during the period of projecting the next frame of image.

In the above-mentioned projection method in the embodiment of the present invention, during the time period in which step S204 is executed twice successively, it is possible to acquire the definition information of one frame of image projected onto the palm surface by the wearable projecting device by means of, for example, an RGB camera. Then the acquired definition information is transmitted to the processing module. The processing module determines whether the definition of projected image is within the predetermined range or not according to the acquired definition information of the projected image. If it is determined that the definition is not within the set threshold range, which indicates the focal length of the lens set is not correctly adjusted, then the processing module corrects the focal length of the lens set according to the determined focal length correction information in the projection period for the next frame, for example, by allowing the displayed images to approach the most clear state in the period for a plurality of frames by an approaching manner, thereby guaranteeing the definition of images displayed on palm by the wearable projecting device.

In the focusing method provided in at least one embodiment of the present invention, the frequency at which the above-mentioned steps S202, S203 and S204 are executed is set to be 30 Hz, and the frequency at which step S205 is executed is 60 Hz.

In at least one embodiment of the present invention, in the above-mentioned step S202, determining the distance between the projection center and the wearable projecting device according to the acquired position information of the projection center, on the palm, of the wearable projecting device may be implemented as follows. First of all, a space coordinates system with an origin at the location of the wearable projecting device is established. Then, the coordinates of the projection center in the space coordinate system is determined according to the acquired position information of the projection center. Thereafter, the distance between the projection center and the wearable projecting device is determined according to the determined coordinates of the projection center and the determined origin coordinates.

In the embodiment of the present invention, the processing module may be implemented by for example a general purpose computer or a dedicated computer (for example DSP).

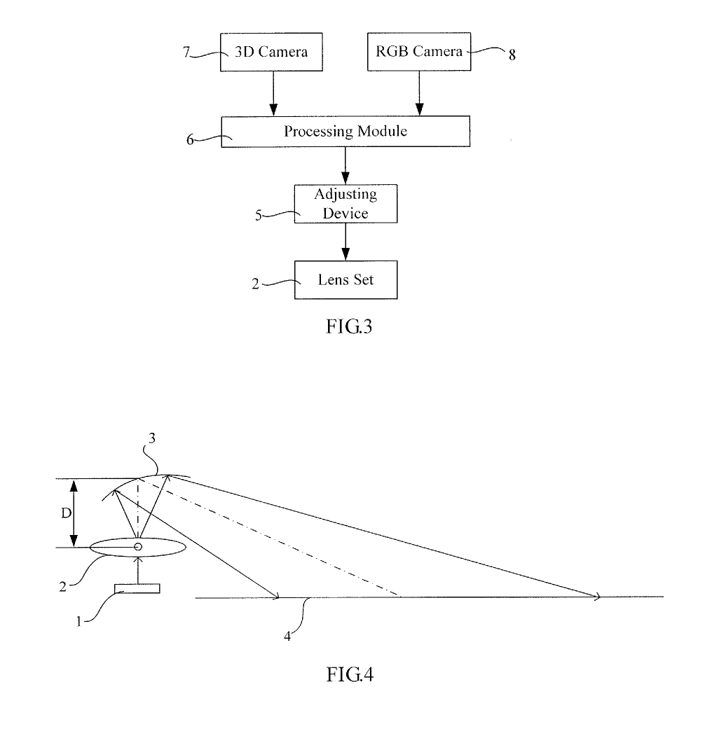

In addition, as shown in FIG. 3, an embodiment of the present invention further provides a wearable projecting device, which comprises: a rack; a lens set 2 mounted on the rack; an adjusting device 5 mounted on the rack and operating for adjusting the focal length of the lens set 2; a 3D camera 7 mounted on the rack for acquiring position information of the projection center, on a palm, of the wearable projecting device; and a processing module 6 in signal connection with the 3D camera 7 and the adjusting device 5.

The processing module 6 is configured to carry out the following operations at a set frequency: determining the distance between the projection center and the wearable projecting device according to the acquired position information of the projection center, on the palm, of the wearable projecting device; and determining the focal length of the lens set 2 in the wearable projecting device according to the determined distance between the projection center and the wearable projecting device and controlling the adjusting device 5 to adjust the focal length of the lens set 2 according to the control signal.

For example, the above-mentioned wearable projecting device may further include an RGB camera 8 in signal connection with the processing module and for acquiring definition information of images projected onto the palm after projecting each frame of image. In the embodiment, the processing module 6 may further have the following function(s): determining whether the definition of projected image is within a predetermined range or not according to the definition information of the projected image acquired by the RGB camera 8, and if not, controlling the adjusting device 5 to correct the focal length of the lens set 2 during the period of projecting the next frame according to determined focal length correction information.

For example, the above-mentioned 3D camera 7 may be a structured-light camera, a TOF (time-of-flight) camera, a binocular camera or the like.

For example, the above-mentioned adjusting device 5 is a stepping motor.

The operation process of the above-mentioned wearable projecting device is described in the projection method provided in the above-mentioned embodiments, and will not be described any more here.

As shown in FIG. 4, the above-mentioned wearable projecting device according to one embodiment of the present invention may further include an arc-shaped reflector 3 on the light-emitting side of the lens set 2. The distance D between the reflector 3 and the lens set 2 is greater than or equal to two times the focal length of the lens set 2. The light-emitting direction of the lens set 2 is away from the palm surface 4, and the projection light emitted from the lens set 2 is reflected by the reflector 3 and irradiates on the palm surface 4, thereby forming a projection pattern on the palm surface 4.

During the time period when the above-mentioned wearable projecting device is implementing projection, the light emitted from the light-emitting module 1 (e.g., an LED) on the light entering side of the lens set 2, after passing through the lens set 2, irradiates the reflector 3 first, and then is reflected by the reflector 3 toward the palm surface 4, thereby reducing the path length of the light emitted from the light-emitting module 1 in the wearable projecting device after passing through the lens set 2, and in turn reducing the path length required by light after exiting the wearable projecting device, resulting in a reduced distance between the wearable projecting device and the palm surface 4 while projecting.

For example, a lens set 2 with a focal length less than or equal to 5 mm can enable the above-mentioned wearable projecting device to conduct projection within 3-10 cm.

What are described above is related to the illustrative embodiments of the disclosure only and not limitative to the scope of the disclosure; the scopes of the disclosure are defined by the accompanying claims.

The present application claims priority of China Patent application No. 201410175303.7 filed on Apr. 28, 2014, the disclosure of which is incorporated in its entirety as part of the present application by reference herein.

1. A focusing method of a wearable projecting device comprising carrying out the following steps at a set frequency:
acquiring position information of a projection center of the wearable projecting device on a palm;
determining a distance between the projection center and the wearable projecting device according to the acquired position information of the projection center of the wearable projecting device on the palm;
determining a focal length of a lens set in the wearable projecting device according to the determined distance between the projection center and the wearable projecting device; and
adjusting the lens set according to the determined focal length of the lens set.

2. The focusing method of claim 1, wherein between two successive executions of adjusting the lens set according to the determined focal length of lens set, the wearable projecting device is controlled to project at least two frames of images, and within a duration of the at least two frames of images, definition information of a projected image on the palm after one frame is projected is further acquired;
then, it is determined whether the definition of the projected image is within a predetermined range or not according to the acquired definition information of the projected image, and if not, the focal length of the lens set is corrected according to determined focal length correction information during the period of projecting the next frame of image.

3. The focusing method of claim 1, wherein the set frequency at which the steps are executed is 30 Hz.

4. A projection method of a wearable projecting device comprising carrying out the following steps at a set frequency:
acquiring position information of a projection center of the wearable projecting device on a palm;
determining a distance between the projection center and the wearable projecting device according to the acquired position information of the projection center of the wearable projecting device on the palm;
determining a focal length of a lens set in the wearable projecting device according to the determined distance between the projection center and the wearable projecting device;
adjusting the lens set according to the determined focal length of the lens set; and
controlling the wearable projecting device to conduct projection.

5. The projection method of claim 4, wherein between two successive executions of adjusting the lens set according to the determined focal length of the lens set, the wearable projecting device is controlled to project at least two frames of images, and within a duration of the at least two frames of images, the method further comprises:
acquiring definition information of an image projected on the palm after one frame of image is projected;
it is determined whether the definition of the projected image is within a predetermined range or not according to the acquired definition information of the projected image, and if not, the focal length of the lens set is corrected according to determined focal length correction information during the period of projecting the next frame of image.

6. The projection method of claim 4, wherein: the set frequency in the carrying out the following steps at a set frequency is 30 Hz; and the projection frequency of the wearable projecting device in the controlling the wearable projecting device to conduct projection is 60 Hz.

7. The projection method of claim 4, wherein, the process of determining the distance between the projection center and the wearable projecting device according to the acquired position information of the projection center of the wearable projecting device on the palm comprises:
establishing a space coordinates system with an origin at a location of the wearable projecting device;
determining coordinates of the projection center in the space coordinate system according to the acquired position information of the projection center;
determining a distance between the projection center and the wearable projecting device according to the determined coordinates of the projection center and coordinates of the determined origin.

8. A wearable projecting device comprising:
a rack,
a lens set mounted on the rack,
an adjusting device mounted on the rack for adjusting a focal length of the lens set in operation;
a 3D camera mounted on the rack for acquiring position information of a projection center of the wearable projecting device on a palm;
a processing module in signal connection with the 3D camera and the adjusting device,
wherein the processing module is configured to carry out the following operations at a set frequency: determining the distance between the projection center and the wearable projecting device according to the acquired position information of the projection center, on the palm, of the wearable projecting device; and determining the focal length of the lens set in the wearable projecting device according to the determined distance between the projection center and the wearable projecting device, generating an adjusting signal and controlling the adjusting device to adjust the focal length of the lens set according to the adjusting signal.

9. The wearable projecting device of claim 8, further comprising: a second camera in signal connection with the processing module for acquiring definition information of images projected onto the palm after each frame of image is projected;
wherein the processing module determines whether definition of a projected image is within a predetermined range according to the definition information of the projected image acquired by the second camera, and if not, controls the adjusting device to correct the focal length of the lens set during the period of projecting the next frame according to determined focal length correction information.

10. The wearable projecting device of claim 9, wherein the second camera is an RGB camera.

11. The wearable projecting device of claim 8, wherein the 3D camera is a structured-light camera, a time of flight camera or a binocular camera.

12. The wearable projecting device of claim 8, wherein the adjusting device is a stepping motor.

13. The wearable projecting device of claim 8, further comprising: an arc-shaped reflector on a light emission side of the lens set,
wherein a distance between the reflector and the lens set is greater than or equal to two times the focal length of the lens set; light emission direction of the lens set is apart from the palm surface, and the projection light emitted from the lens set irradiates on the palm surface after being reflected by the reflector to form a projection image on the palm surface.

14. The wearable projecting device of claim 8, wherein the focal length of the lens set is less than or equal to 5 mm.

15. The focusing method of claim 2, wherein the set frequency at which the steps are executed is 30 Hz.

16. The projection method of claim 5, wherein: the set frequency in the carrying out the following steps at a set frequency is 30 Hz; and the projection frequency of the wearable projecting device in the controlling the wearable projecting device to conduct projection is 60 Hz.

17. The projection method of claim 5, wherein, the process of determining the distance between the projection center and the wearable projecting device according to the acquired position information of the projection center of the wearable projecting device on the palm comprises:
establishing a space coordinates system with an origin at a location of the wearable projecting device;
determining coordinates of the projection center in the space coordinate system according to the acquired position information of the projection center;
determining a distance between the projection center and the wearable projecting device according to the determined coordinates of the projection center and coordinates of the determined origin.

18. The wearable projecting device of claim 9, wherein the 3D camera is a structured-light camera, a time of flight camera or a binocular camera.

19. The wearable projecting device of claim 9, wherein the adjusting device is a stepping motor.

20. The wearable projecting device of claim 8, further comprising: an arc-shaped reflector on a light emission side of the lens set,
wherein a distance between the reflector and the lens set is greater than or equal to two times the focal length of the lens set; light emission direction of the lens set is apart from the palm surface, and the projection light emitted from the lens set irradiates on the palm surface after being reflected by the reflector to form a projection image on the palm surface.
